(19) United States
(12) Patent Application Publication
(10) Pub. No.: US 2006/0054624 A1
(43) Pub. Date: Mar. 16, 2006

(54) Cup cover structure

(76) Inventor: Ching-Yuan Wang, Taipei (TW)

Correspondence Address: BACON & THOMAS, PLLC, 625 SLATERS LANE, FOURTH FLOOR, ALEXANDRIA, VA, 22314, US

(21) Appl. No.: 10/939,496

(22) Filed: Sep. 14, 2004

(51) Int. Cl. B65D 51/26; G01D 13/22

(52) U.S. Cl. 220/212; 362/800; 116/300

(57) ABSTRACT

The present invention discloses a cup cover structure, which comprises at least one light emitting device or sound amplifier disposed around the periphery of a circular cover, and a control circuit disposed inside the circular cover for controlling the light emitting device or sound amplifier, and the control circuit is connected to a switch, such that when the cup cover structure is in use, the circular cover is sheathed around a cup, and the switch is turned on, and the control circuit drives the light emitting device to emit light or the sound amplifier to emit sound or simultaneously emit light and sound as to give more fun to children and attract their attention and curiosity as well as encourage them to drink more water.

### BACKGROUND OF THE INVENTION

1. Field of the Invention

The present invention relates to a cup cover structure being sheathed onto a cup body and capable of emitting lights or sounds to attract children's attention and curiosity and providing a drinking cup with fin for children.

2. Description of the Related Art

Cup is an indispensable item to our daily life; regardless of the materials it is made, a cup is still a cup, and even the cup is painted with different colors or various patterns, the patterns are still static, and such patterns can no longer attract children's interest after being used for a while and thus cannot achieve the purpose of encouraging them to drink water anymore.

In view of the foregoing shortcoming, some people improved the cup structure by the technology as disclosed in R.O.C. Patent No. 87211563 (Publication No. 357587). Please refer to FIG. 1 for the cup structure disclosed in that patent, which relates to a light emitting cup structure. The light emitting cup structure comprises a cup body and a base; wherein the cup body is integrally formed and has an internal wall and an external wall and a gap between the internal and external walls; and the base comprises a cold light electroluminescent plate; a plurality of partitions being disposed at the bottom of the base to define a plurality of accommodating grooves, and the accommodating grooves being disposed at the bottom of the base for accommodating a circuit board which is electrically connected to the circuit of the cold light electroluminescent plate, a power supply and the switch; and a cover plate being fixed to the bottom of the base and the cover plate having a through hole corresponding to the power supply, and a removable lifting lid being disposed at the through holes, and the pressing section of the foregoing switch being protruded from the cover plate; such that the base can be fixed onto the bottom of the cup body and the cold light electroluminescent plate is located precisely in the gap of the cup body to constitute a light emitting cup.

Although the power supply is turned on by the switch to supply sufficient electric power to control the cold light electroluminescent plate and drive the cold light electroluminescent plate to emit light. However, such cup must have the internal and external walls, and the internal and external walls must have an appropriate space for accommodating the cold light electroluminescent plate. Such arrangement not only makes the manufacturing complicated, but also requires the cup body to be manufactured according to the aforementioned patent to achieve the light emitting effect. For children who like to have changes from time to time, such cup will lose its attraction after being used for some time. Furthermore, the base must be able to accommodate the circuit board and the power supply, and thus the base must have a certain substantial height and a certain substantial weight, which could be a burden for children to use.

### SUMMARY OF THE INVENTION

In view of the foregoing shortcomings of the prior art cup body including its monotonous and dull application and incapability of being used universally to any cup body, therefore the inventor of the present invention focused on the problems to start finding a way for the improvement and overcome the shortcomings in hope of finding a feasible solution, and conducted extensive researches and experiments and finally invented the cup cover structure in accordance with the present invention.

Therefore, it is the primary objective of the present invention to provide a cup cover structure, which comprises a circular cover and the area of the circular cover can be varied according to the size of the cup body; at least one light emitting device or sound amplifier disposed around the periphery of a circular cover; and a control circuit disposed inside the circular cover for controlling the light emitting device or sound amplifier, and the control circuit is connected to a switch, such that when the cup cover structure is in use, the circular cover is sheathed around any cup body, and the switch is turned on, and the control circuit drives the light emitting device to emit light or the sound amplifier. The invention not only allows users to change the cup body from time to time according to their preference, but also satisfy children's curiosity for new matters. Besides, the manufacture of such cup body is not as complicated as the prior art, and thus can save the manufacturing cost.

### BRIEF DESCRIPTION OF THE DRAWINGS

The above objects, features and advantages of the present invention will become apparent from the following detailed description taken with the accompanying drawing. However, these drawings are provided for reference and illustration and not intended to act as a limitation to the present invention.

FIG. 1 is an exploded view of the cup structure according to a prior art.

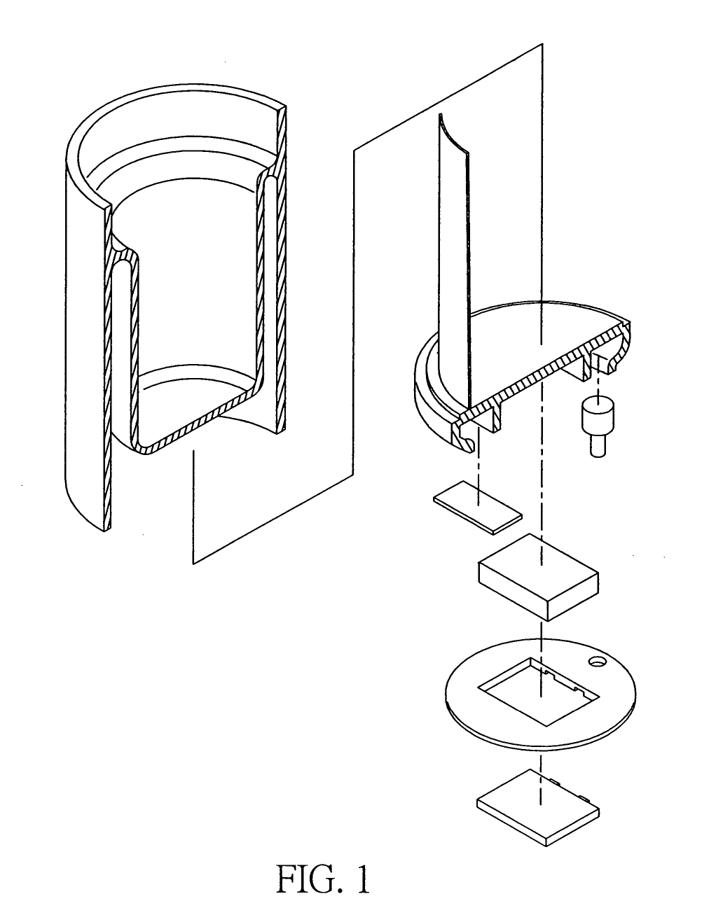

FIG. 2 is a perspective view of the cup structure according to the present invention.

FIG. 3 is a perspective view of the cup structure according to a preferred embodiment of the present invention.

FIG. 4 is a perspective view of the cup structure emitting light according to a preferred embodiment of the present invention.

FIG. 5 is a schematic circuit diagram of the present invention.

### DETAILED DESCRIPTION OF THE PREFERRED EMBODIMENTS

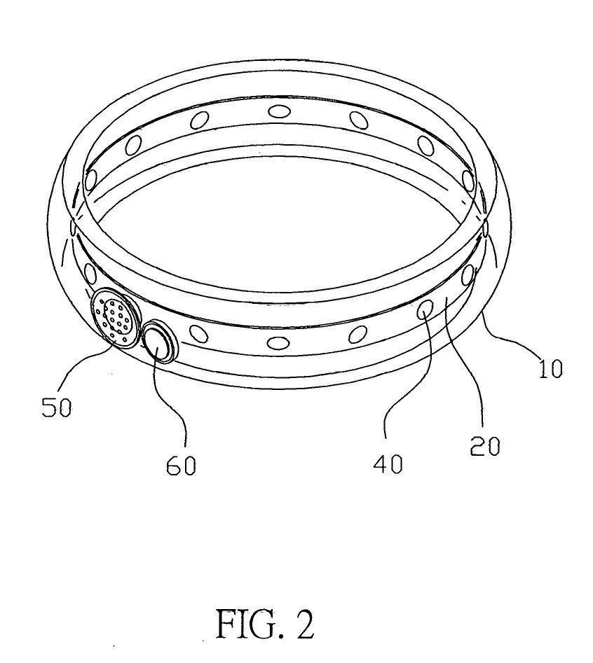

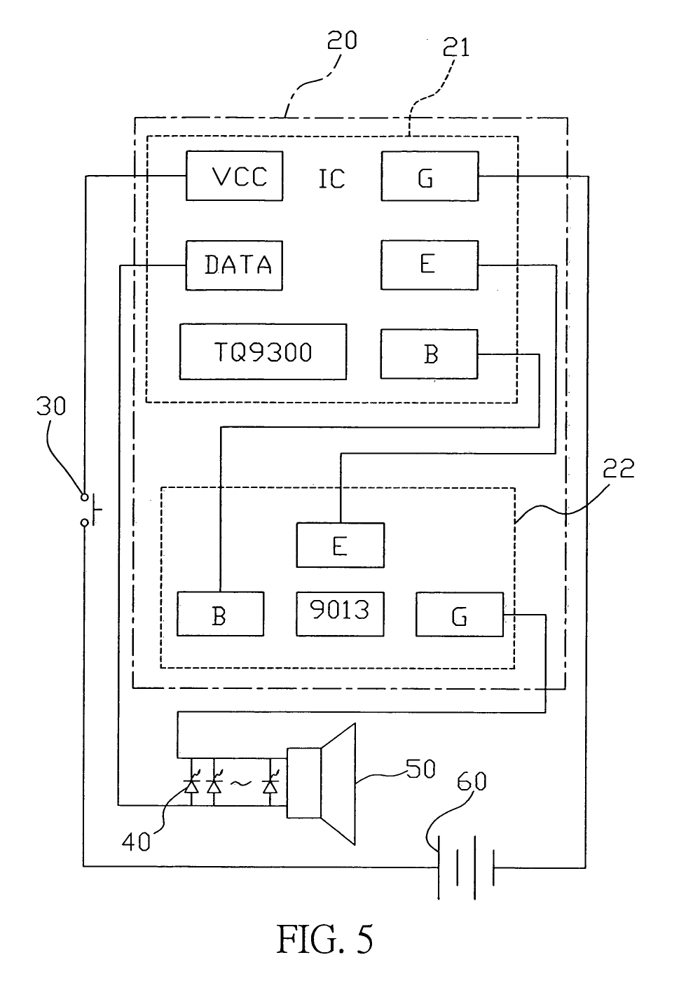

Please refer to FIGS. 2 and 5 for a cup cover structure according to the present invention. The cup cover structure comprises: a circular cover 10, and the circular cover 10 adopted by this embodiment is annular in shape but not limited to such shape, and the persons skilled in the art may change its shape; a control circuit 20 disposed in the circular cover 10 and the control circuit 20 is electrically connected to a switch 30, and the switch 30 could be a switching type switch or a mercury touch control type switch, and the control circuit 20 is electrically connected to at least one light emitting device 40 or sound amplifier 50 or both light emitting device 40 and sound amplifier 50, and the light emitting device 40 and the sound amplifier 50 are disposed around the periphery of the circular cover 10 and the light emitting 40 adopted by this embodiment is a light emitting diode and the sound amplifier 50 is a loudspeaker.

Please refer to FIG. 5. The control circuit 20 has a control IC 21 with a product number TQ9300, and the control IC 21 has a Vcc terminal, a switch 30 and a power supply 60 (which is a battery in this embodiment) connected in series, and the power supply 60 is electrically connected to the gate G of the control IC 21. Further, the emitter E and the source B of the control circuit IC 21 are connected respectively with the emitter E and the source B of a transistor 22, and the transistor 22 has a product number of 9013. The gate G of the transistor 22 is connected to the sound amplifier 50 or the light emitting device 40, and the sound amplifier 50 or the light emitting device 40 is connected with the data terminal DATA of the control IC 21, such that when the cup cover structure is in use, the switch 30 is used to turn on or off the power supply 60 for an electric connection or disconnection. If the power supply 60 is electrically connected, the control IC 21 will send signals out from the data terminal to the light emitting device 40, so that the light emitting device 40 will emit different variable lights or sounds according to the instructions given by the control IC 21.

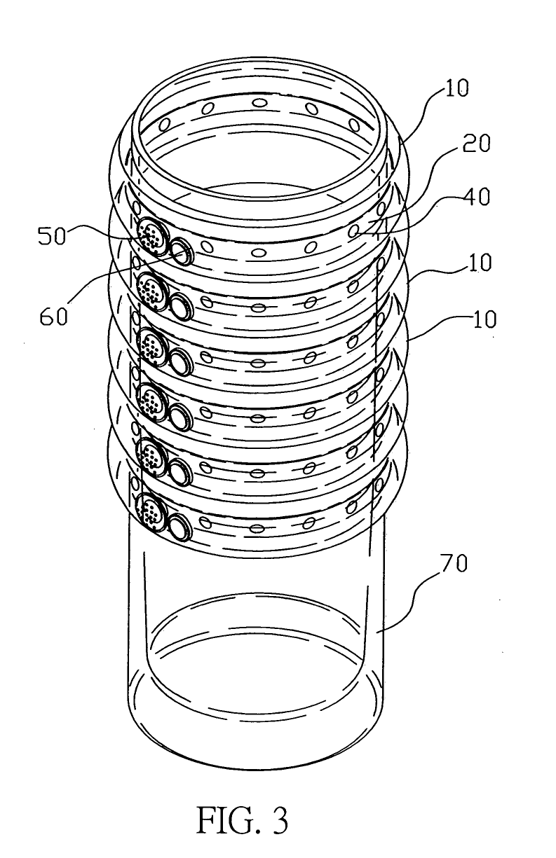

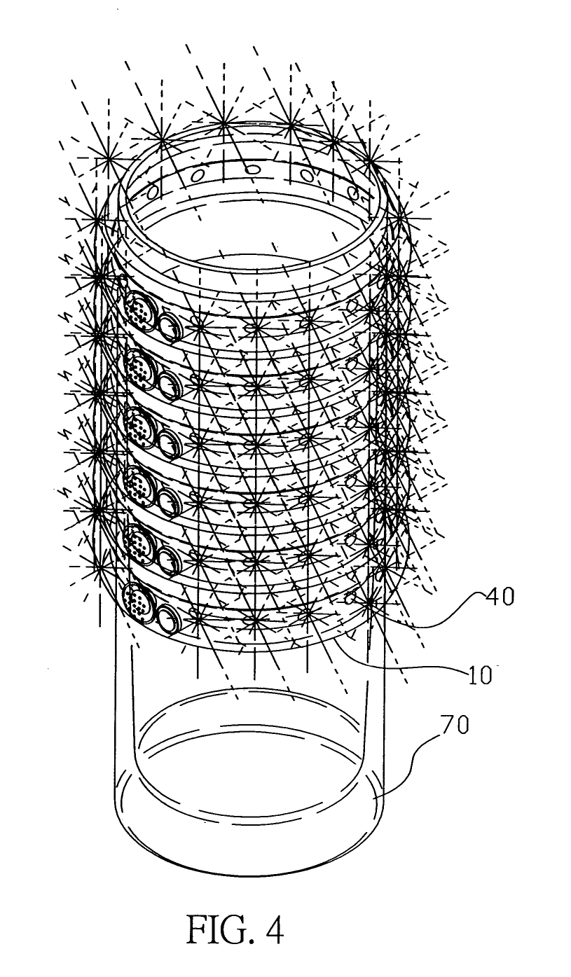

Please refer to FIGS. 3 and 4 for another preferred embodiment of the present invention. When the cup cover structure is in use, a circular cover 10 is sheathed around the periphery of a cup body 70 or a plurality of the circular covers 10 is sheathed around the periphery of the cop body 70, and the switch 30 is turned on by hand or by shaking the cup as to electrically connect with the power supply 60 such that the control IC 21 is electrically connected to the power supply 60 and sends a signal from a data terminal to a light emitting device 40, so that the light emitting device 40 will emit different variable lights or sounds according to the instructions given by the control IC 21 to give more fin to children for its use. The cup cover structure of the invention can be used extensively in any cup body, and thus it broadens the scope of applications.

In summation of the description above, the cup cover structure according to the present invention definitely makes the structure simpler and the use more convenient, and the invention also improves the user's willingness for the use. Therefore the present invention can overcome the shortcomings of the prior art and improve its utility.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A cup cover structure, comprising:
a circular cover, being hollow inside;
a control circuit, being installed in said circular cover;
at least one light emitting device, being disposed around the periphery of said circular cover, and said light emitting device being electrically coupled to said control circuit for receiving a signal from said control circuit to emit different lights;
a power supply, being electrically coupled to said control circuit; and
a switch, being electrically coupled to said control circuit for selectively turning on and off said power supply;
thereby, when said cup cover structure comprised of foregoing components is in use, said circular cover is sheathed around a cup and said switch is turned on and said control circuit drives said light emitting device to emit light.

2. The cup cover structure of claim 1, wherein said light emitting device is a light emitting diode.

3. The cup cover structure of claim 1, wherein said switch is a switching type switch.

4. The cup cover structure of claim 1, wherein said switch is a mercury touch control type switch.

5. The cup cover structure of claim 1, wherein said circular cover further comprises a sound amplifier being electrically coupled to said control circuit.

6. The cup cover structure of claim 5, wherein said sound amplifier is a loudspeaker.
